(19) United States
(12) Patent Application Publication
(10) Pub. No.: US 2026/0304166 A1
(43) Pub. Date: Oct. 1, 2026

(54) TERMINAL, BASE STATION, AND COMMUNICATION METHOD

(71) Applicant: Panasonic Intellectual Property Corporation of America, Torrance, CA (US)

(72) Inventors: Tetsuya YAMAMOTO, Kanagawa (JP); Shotaro MAKI, Tokyo (JP); Ayako HORIUCHI, Kanagawa (JP)

(73) Assignee: Panasonic Intellectual Property Corporation of America, Torrance, CA (US)

(21) Appl. No.: 19/475,648

(22) PCT Filed: Jan. 22, 2024
(86) PCT No.: PCT/JP2024/001629

§ 371 Date: Oct. 15, 2025

(30) Foreign Application Priority Data
Apr. 25, 2023 (JP) 2023-071359

(51) Int. Cl. H04W 24/06; H04B 17/391; H04L 5/00; H04L 41/16

(52) U.S. Cl. CPC H04W 24/06; H04B 17/3913; H04L 5/0057; H04L 41/16

(57) ABSTRACT

This terminal is provided with: a reception circuitry for receiving, with regards to channel state information generated on the basis of a terminal-side generation model, first information pertaining to a first model simulating a network-side reconstruction model, the first model being applied to a plurality of artificial intelligence models or a plurality of uses; and a transmission circuitry for transmitting a signal pertaining to an artificial intelligence model and/or the channel state information, on the basis of the first information.

### TECHNICAL FIELD

The present disclosure relates to a terminal, a base station, and a communication method.

### BACKGROUND ART

In recent years, a dramatic growth of Internet of Things (IoT) has been expected with the expansion and diversification of radio services as a background. The usage of mobile communication is expanding to all fields such as automobiles, houses, home electric appliances, or industrial equipment in addition to information terminals such as smartphones. In order to support the diversification of services, a substantial improvement in the performance and function of mobile communication systems has been required for various requirements such as an increase in the number of connected devices or low latency in addition to an increase in system capacity. The 5th generation mobile communication system (5G) has features such as enhanced mobile broadband (eMBB), massive machine type communication (mMTC), and ultra reliable and low latency communication (URLLC, and flexibly provides radio communication in response to a wide variety of needs.

The 3rd Generation Partnership Project (3GPP) as an international standardizing body has been specifying New Radio (NR) as one of 5G radio interfaces.

### CITATION LIST

### Non-Patent Literature (Hereinafter, Referred to as “NPL”)

### NPL 1

RP-213599, “New SI: Study on Artificial Intelligence (AI)/Machine Learning (ML) for NR Air Interface,” Qualcomm (Moderator). December 2021.

### NPL 2

RI-2300445, “Other aspects on AI/ML for CSI feedback enhancement,” vivo, February 2023.

### SUMMARY OF INVENTION

However, there is room for study on a method for improving the efficiency of radio communication.

One non-limiting exemplary embodiment facilitates providing a base station, a terminal, and a communication method each capable of improving the efficiency of radio communication.

A terminal according to one embodiment of the present disclosure includes: reception circuitry, which, in operation, receives first information related to a first model that emulates a reconstruction model on a network side with respect to channel state information generated based on a generation model on a terminal side, the first model targeting a plurality of artificial intelligence models or a plurality of applications; and transmission circuitry, which, in operation, transmits a signal related to at least one of an artificial intelligence model and/or the channel state information, based on the first information.

It should be noted that general or specific embodiments may be implemented as a system, a method, an integrated circuit, a computer program, a storage medium, or any selective combination thereof.

According to one embodiment of the present disclosure, it is possible to improve the efficiency of radio communication.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an example of compression of Channel State Information (CSI) in spatial and frequency domains, which utilizes a Machine Learning (ML)/Artificial Intelligence (AI) technology;

FIG. 2 is a diagram illustrating a Channel Quality Indicator (CQI) generation example;

FIG. 3 is a diagram illustrating another CQI generation example;

FIG. 4 is a diagram illustrating an example of performance monitoring for an AI/ML model;

FIG. 5 is a diagram illustrating another example of the performance monitoring for the AI/ML model;

FIG. 6 is a block diagram illustrating a configuration example of a part of a base station;

FIG. 7 is a block diagram illustrating a configuration example of a part of a terminal;

FIG. 8 is a diagram illustrating an example of assistance information;

FIG. 9 is a diagram illustrating an operation example of the terminal and the base station:

FIG. 10 is a diagram illustrating an example of assistance information;

FIG. 11 is a diagram illustrating another example of assistance information;

FIG. 12 is a diagram illustrating another operation example of the terminal and the base station:

FIG. 13 is a diagram illustrating another example of assistance information;

FIG. 14 is a diagram illustrating an operation example of the terminal and the base station;

FIG. 15 is a diagram illustrating an example of an architecture;

FIG. 16 is a block diagram illustrating a configuration example of the base station:

FIG. 17 is a block diagram illustrating a configuration example of the terminal:

FIG. 18 is a block diagram illustrating a configuration example of a controller of the terminal:

FIG. 19 is a diagram of an exemplary architecture of a 3GPP NR system;

FIG. 20 is a schematic diagram illustrating functional separation between NG-RAN and 5GC;

FIG. 21 is a sequence diagram of Radio Resource Control (RRC) connection setup/reconfiguration procedure:

FIG. 22 schematically illustrates usage scenarios of enhanced Mobile BroadBand (eMBB), massive Machine Type Communications (mMTC), and Ultra Reliable and Low Latency Communications (URLLC); and

FIG. 23 is a block diagram illustrating an exemplary 5G system architecture for anon-roaming scenario.

### DESCRIPTION OF EMBODIMENTS

Hereinafter, embodiments of the present disclosure will be described in detail with reference to the accompanying drawings.

In NR, for example, an access scheme based on Orthogonal Frequency Division Multiplexing (OFDM) is employed for downlink transmission. Further, Multiple-Input Multiple-Output (MIMO) is employed in order to increase a data rate. In order to effectively bring out the performance of MIMO, a closed-loop control is introduced, and channel state information (CSI) feedback is performed from a terminal (e.g., also referred to as user equipment (UE)) to a base station (e.g., also referred to as gNB). It is expected that the feedback of the CSI achieves high performance with a smaller amount of control information.

In 3GPP Release 18 (e.g., also referred to as Rel. 18), utilizing Artificial Intelligence (AI) such as Machine Learning (ML) (hereinafter, also referred to as “AI/ML”) in the radio interface of NR (e.g., NPL 1) has been discussed. As a use case where the AI/ML technology is utilized, for example, CSI feedback, beam control, and position estimation have been studied.

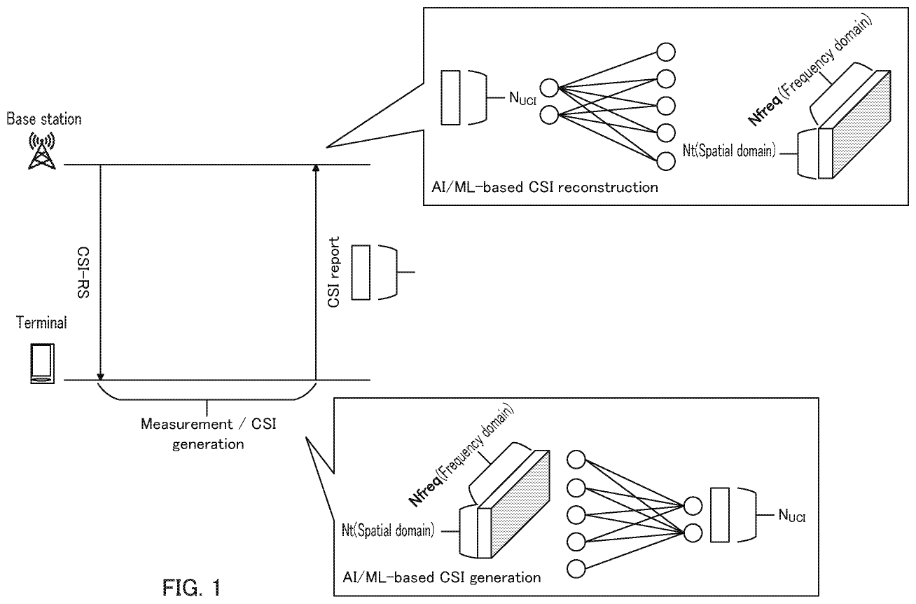

For example, for the CSI feedback, a method of compressing the amount of CSI information in a spatial domain and a frequency domain while utilizing the AI/ML technology (hereinafter, also referred to as CSI compression) has been studied. For example, in machine learning, it is possible to automatically extract features of a huge amount of training data by training an AI/ML model (e.g., an artificial intelligence model) such as a neural network with the huge amount of training data. In CSI compression, for example, an algorithm mainly for dimension compression and reconstruction of image data, which is called an autoencoder, can be used. For example, as illustrated in FIG. 1, a CSI matrix represented by a two-dimensional region in the spatial domain and the frequency domain is regarded as an image, an encoder used for the compression of the autoencoder is used for CSI compression processing on a terminal side, and a decoder that performs the reconstruction is used for CSI reconstruction processing on a base station or network (e.g., also referred to as “base station/network”) side.

### [Regarding CQI Report]

CSI feedback (or CSI report) in NR may include a Rank Indicator (RI), a Precoding Matrix Indicator (PMI), and a Channel Quality Indicator (CQI) in accordance with parameter settings by the base station. For example, in the case of an existing Type II codebook, the RI, the PMI, and the CQI are simultaneously reported in the CSI report. In this case, the RI and the CQI to be reported are calculated using the PMI calculated on the terminal side. The base station may transmit downlink data in accordance with the received RI, CQI, and PMI. In the above-described CSI report, since the PMI matches the RI and the CQL the base station uses the PMI as a precoder for downlink data transmission and transmits the downlink data using the number of transmission ranks (or layers) or a modulation and coding scheme (MCS) determined with reference to the RI and the CQI, and thus improvement in system performance can be expected.

Meanwhile, in the case of CSI compression using a two-sided model in which an encoder that performs the compression is used on the terminal side and a decoder that performs the reconstruction is used on the base station/network side, the compressed CSI is reconstructed by using the decoder on the base station/network side. In the base station/network, it is assumed that a precoder of the downlink data is calculated using the reconstructed CSI. In this case, in a case where the terminal reports the RI and the CQI in addition to the compressed CSI in the CSI report, as in the existing method, the following cases may occur.

### <Case 1: CQI is Generated Based on Target CSI (Input to CSI Report Generator)>

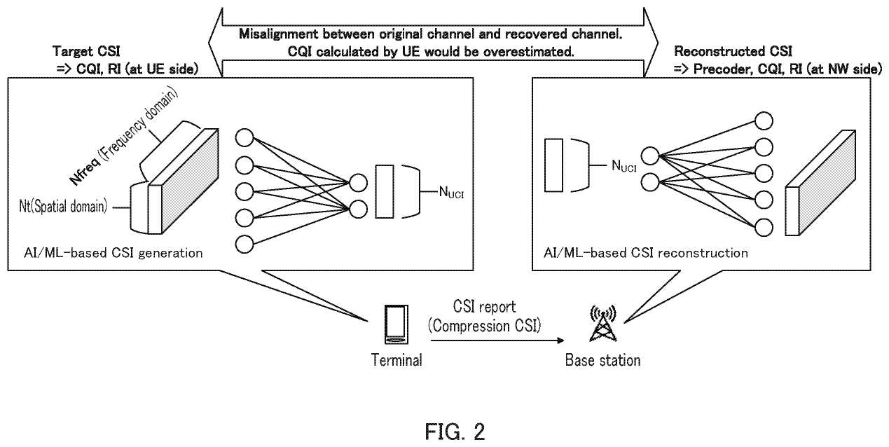

As illustrated in FIG. 2, the CSI report from the terminal may include the RI and the CQI in addition to the compressed CSI (compression CSI). The terminal calculates the RI and the CQI to be reported using the input CSI (hereinafter, referred to as “target CSI”) of a CSI report generator (CSI compressor).

In this case, since the target CSI (CSI before compression) and the CSI reconstructed by the base station may be different from each other, a misalignment may occur between the target CSI and the CSI reconstructed by the base station. For example, the base station can generate a precoder for downlink data transmission by using the reconstructed CSI. Further, the base station can determine the number of transmission ranks (or layers) or the MCS with reference to the received RI and CQI and transmit the downlink data. For example, since the RI and the CQI received by the base station are calculated based on the target CSI (CSI before compression) on the terminal side, in a case where a misalignment occurs between the target CSI and the CSI reconstructed by the base station, the RI and the CQI do not necessarily match the CSI reconstructed by the base station, and possibly become values calculated from the CSI that is overestimated as compared with the CSI reconstructed by the base station.

In such a case, the base station uses the precoder generated by using the CSI reconstructed by the base station for the downlink data transmission and transmits the downlink data using the number of transmission ranks (or layers) and the MCS determined with reference to the RI and the CQI (e.g., the RI and the CQI that are overestimated) received from the terminal. Therefore, there is a possibility that the effect of improving the system performance is not sufficiently obtained.

### <Case 2: CQI is Generated Based on Output of CSI Reconstructor>

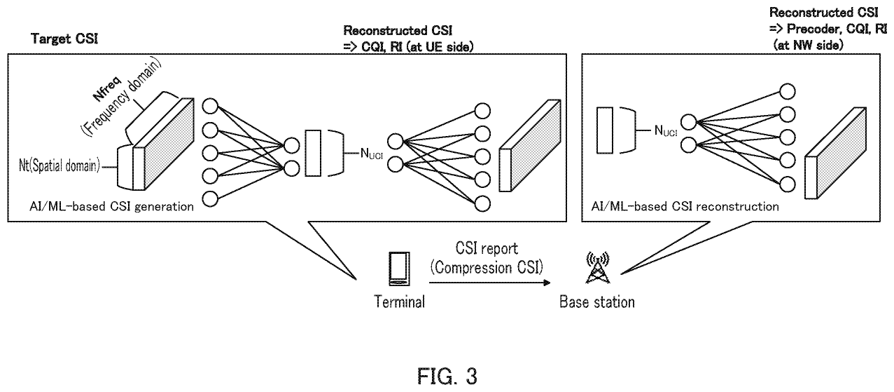

As illustrated in FIG. 3, the CSI report from the terminal may include the RI and the CQI in addition to the compressed CSI. The terminal calculates the RI and the CQI to be reported by using the output of the CSI reconstructor.

In this case, there is a premise that the AI/ML model of the CSI reconstructor used on the base station/network side is known to the terminal, and the terminal can execute inference processing of the AI/ML model of the CSI reconstructor. For example, under this premise, there is a possibility that a burden of power consumption, storage, and calculation on the terminal is increased, and it is not expected that the terminal side holds and executes the AI/ML model of the CSI reconstructor used on the base station/network side.

Further, in general, the AI/ML model of the CSI reconstructor used on the base station/network side is an original design of the base station/network side. It is not desirable that the base station/network vendor shares the AI/ML model information used in an original CSI reconstructor with the terminal vendor.

### [Regarding AI/ML Model Performance Monitoring]

In the CSI compression using the two-sided model in which an encoder that performs the compression is used on the terminal side and a decoder that performs the reconstruction is used on the base station/network side, it is expected to monitor the performance of the AI/ML model in order to ensure availability of the AI/ML model of the CSI compressor on the terminal side and the AI/ML model of the CSI reconstructor on the base station/network side.

For example, as a case where the availability of the AI/ML model deteriorates, the following case is assumed: an AT/ML model trained in a certain environment (e.g., a specific cell, cell #A) is used in the same environment as the training environment (e.g., cell #A), but the environment changes (e.g., cell #B) due to Mobility or the like of the terminal, and the AI/ML model currently being used does not match the training environment (e.g., cell #A), resulting in deterioration in performance of the AI/ML model. In this case, it is expected that the terminal performs appropriate processing such as switching to use the AI/ML model (e.g., the AI/ML model trained in the environment of cell #B) suitable for the changed environment (e.g., cell #B) or stopping the processing of the CSI compression using the AI/ML.

In order to appropriately operate the AI/ML model as described above, it is expected to monitor the performance of the AI/ML model currently being operated or the performance of the AI/ML model that is not currently being operated but is possibly switched.

As one technique for monitoring the performance of the AI/ML model, a method for monitoring the performance of the AI/ML model on the terminal side has been discussed. Further, a method for monitoring the performance by evaluating an intermediate key performance indicator (KPI) (Intermediate KPI) as a KPI for the performance monitoring has been discussed. For example, a Normalized Mean Square Error (NMSE) or a Square Generalized Cosine Similarity (SGCS) calculated using the input CSI (target CSI) of the CSI report generator and the output CSI of the CSI reconstructor can be used as the Intermediate KPI. The following cases are assumed in the performance monitoring for the AI/ML model.

<Case 1: Monitoring Based on Output CSI of CSI Reconstructor Indicated from Base Station/Network Side>

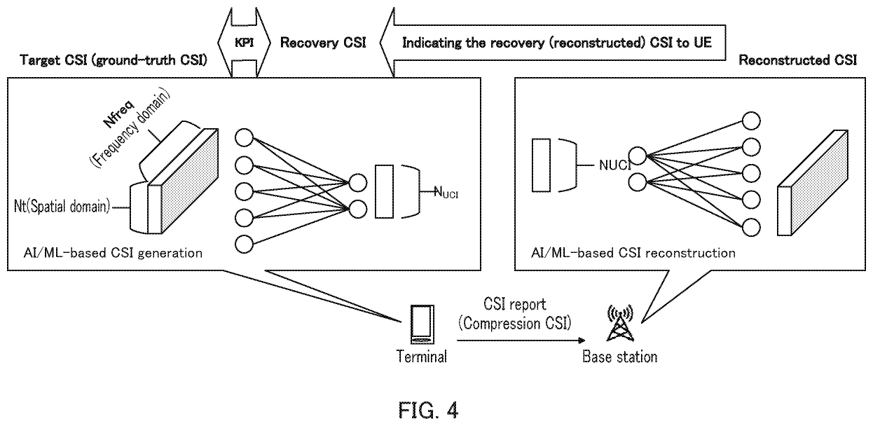

As illustrated in FIG. 4, the base station reconstructs (recovers) the compressed CSI reported by the terminal, using the CSI reconstructor, and indicates the reconstructed CSI (e.g., also referred to as “recovery CSI”) to the terminal. The terminal calculates the Intermediate KPI using the input CSI (target CSI or ground-truth CST) of the CSI report generator generated by the terminal through measurement and the output CSI (recovery CST) of the CSI reconstructor received from the base station.

In this case, an overhead for indicating the CSI reconstructed by the base station to the terminal occurs.

### <Case 2: Monitoring on Terminal Side Based on Output of CSI Reconstructor on Terminal Side>

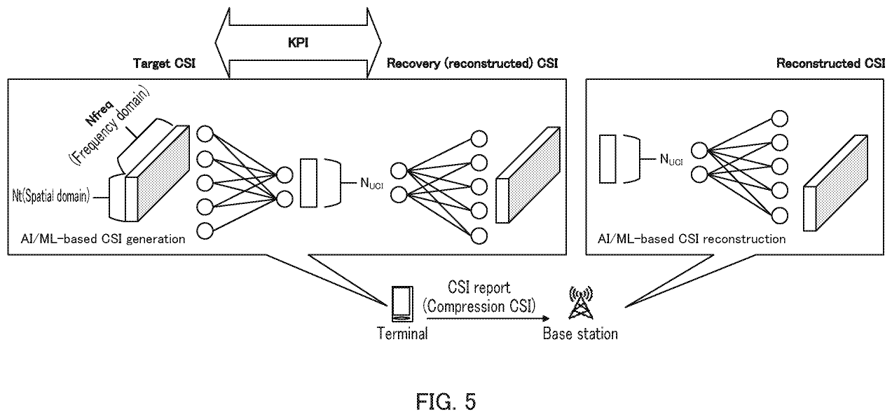

In this case, there is a premise that the AI/ML model of the CSI reconstructor used on the base station/network side is known to the terminal, and the terminal can execute inference processing of the AI/ML model of the CSI reconstructor In this case, as illustrated in FIG. 5, the terminal can obtain the output of the CSI reconstructor used on the base station/network side. The terminal calculates the Intermediate KPI using the input CSI (target CSI or ground-truth CSI) of the CSI report generator generated by the terminal through measurement and the output CSI (recovery CSI) of the CSI reconstructor generated by the terminal.

For example, under this premise, there is a possibility that a burden of power consumption, storage, and calculation on the terminal is increased, and it is not expected that the terminal side holds and executes the AI/ML model of the CSI reconstructor used on the base station/network side.

Further, in general, the AI/ML model of the CSI reconstructor used on the base station/network side is an original design of the base station/network side. It is not desirable that the base station/network vendor shares the AI/ML model information used in an original CSI reconstructor with the terminal vendor.

### [Regarding Proxy Model]

In the monitoring based on the output of the CSI reconstructor on the terminal side (Case 2 of the performance monitoring described above), a method of using a proxy model has been discussed (e.g., see NPL 2).

The proxy model is a model that has been trained to emulate an actual model. The proxy model is a model having a much simpler structure and fewer parameters than the actual model. Application of the proxy model makes it relatively easy to transfer/deliver (delivery) the proxy model from the base station/network side to the terminal side and thus makes it possible to reduce the overhead, the originality of the model specification, and the problem related to compatibility that the CSI reconstructor on the base station/network side cannot be executed on the terminal side in terms of the processing amount.

Meanwhile, there is a possibility that the proxy model cannot achieve the same performance as the actual model. Therefore, in order to maintain the accuracy of the performance monitoring using the proxy model, a difference or the like in Intermediate KPI for the actual model can be trained.

Further, in the monitoring on the terminal side based on the output of the proxy model in which the CST reconstructor is replaced, the following cases may occur.

One case is that, in the performance monitoring for the AI/ML model, it is expected that the terminal monitors the performance expected to be achieved by the AI/ML model that is not currently activated (not activated) (e.g., also referred to as a “target AI/ML model”), in addition to the performance of the currently activated AI/ML model, in order to implement efficient switching of the AI/ML model. For example, for the efficient switching of the AT/ML model, it is assumed that, in a case where the training environment of the currently activated AI/ML model is different from an actual environment due to a change in a channel, and the performance of the currently activated AT/ML model deteriorates, an operation of deactivating the currently activated AI/ML model and activating another AI/ML model suitable for the actual environment is performed.

It is assumed that the terminal calculates the Intermediate KPI using the proxy model corresponding to each of the currently activated AT/ML model and the currently-not activated AI/ML model (AT/ML model as a switching candidate). For example, as described above, even in a case where the proxy model is a model having a much simpler structure and fewer parameters than the actual model, calculating the Intermediate KPI by the terminal while holding a plurality of proxy models and executing inference of the plurality of proxy models possibly increases a load on the terminal.

Further, for example, in case of operating a scenario/configuration unique AI/ML model or a cell/site unique AI/ML model, when Mobility occurs, in which the terminal moves from a certain cell to another cell, there is a possibility that the AI/ML model such as the CSI generation model and the CSI reconstruction model is changed between cells. Along with the change of the AI/ML model between the cells, in order to correspond to the changed CSI generation model and the changed CSI reconstruction model, the new proxy model may be transferred/delivered from the base station/network side to the terminal side, which may increase an overhead for updating the proxy model.

In one non-limiting embodiment of the present disclosure, a description will be given of a method for efficiently executing performance monitoring for a plurality of AI/ML models or a plurality of pieces of processing with different applications, such as CQI report, while suppressing an increase in processing load of a terminal in a case a the proxy model is applied.

For example, a description will be given of a method for efficiently executing the performance monitoring for a plurality of AI/ML models or a plurality of pieces of processing with different applications, such as performance monitoring and CQI calculation, while suppressing an increase in processing load of a terminal in a case where the terminal holds a proxy model in which a structure and parameters are simplified as compared with an actual AI/ML model (e.g., also referred to as a “Full model”) mainly for the purpose of calculating an Intermediate KPI.

For example, the terminal receives an indication of a proxy model targeting a plurality of AI/ML models or a plurality of applications (e.g., performance monitoring, CQI report, and the like). Further, the terminal receives an indication of assistance information (e.g., assistance information) for emulating an actual model for a specific model or a specific application, using the proxy model.

As a result, the terminal can suppress the number of proxy models which are held by the terminal for emulating the plurality of A/ML models and for which the inference processing is executed. Therefore, it is made possible to reduce the calculation processing amount, the storage, the power consumption, and the problem related to compatibility that the CSI reconstructor on the base station/network side cannot be executed on the terminal side in terms of the processing amount.

Further, suppressing the number of proxy models which are held by the terminal for emulating the plurality of AI/ML models and for which the inference processing is executed makes it possible to reduce the overhead related to the transfer/delivery of the proxy model when the Mobility of the terminal occurs.

Hereinafter, non-limiting embodiments of the present disclosure will be described.

### [Overview of Communication System]

A communication system according to one aspect of the present disclosure includes, for example, at least one base station and at least one terminal.

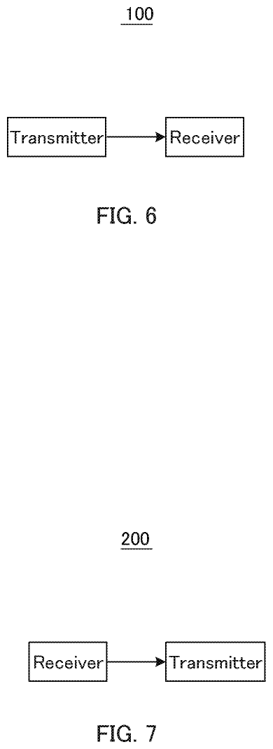

FIG. 6 is a block diagram illustrating a configuration example of a part of base station 100 according to an embodiment of the present disclosure, and FIG. 7 is a block diagram illustrating a configuration example of a part of terminal 200 according to the embodiment of the present disclosure.

In base station 100 illustrated in FIG. 6, a transmitter (e.g., corresponding to transmission circuitry) transmits first information related to a first model (proxy model) that emulates a reconstruction model (e.g., a CSI reconstruction model) on abase station/network side with respect to channel state information (CSI) generated based on a generation model (e.g., a CST generation model) on a terminal side. The first model targets a plurality of artificial intelligence models (AI/ML models) or a plurality of applications. A receiver (e.g., corresponding to reception circuitry) receives a signal (e.g., an Intermediate KPI, a failure report of the AI/ML model, a switching request for the AI/ML model, or a CQI) related to at least one of the artificial intelligence model and the channel state report, generated based on the first information.

In terminal 200 illustrated in FIG. 7, a receiver (e.g., corresponding to reception circuitry) receives first information related to the first model (proxy model) that emulates a reconstruction model (e.g., a CSI reconstruction model) on the base station/network side with respect to channel state information (CSI) generated based on the generation model (e.g., a CSI generation model) on the terminal side. The first model targets a plurality of artificial intelligence models (AI/ML models) or a plurality of applications. A transmitter (e.g., corresponding to transmission circuitry) transmits a signal (e.g., an Intermediate KPI, a failure report of the AI/ML model, a switching request for the AT/ML model, or a CQI) related to at least one of the artificial intelligence model and the channel state information based on the first information.

### Embodiment 1

In the present embodiment, it is assumed that terminal 200 performs performance monitoring on a terminal side based on output of a proxy model that emulates an AI/ML model (e.g., CSI reconstruction model) of a CSI reconstructor on a base station/network side (e.g., base station 100).

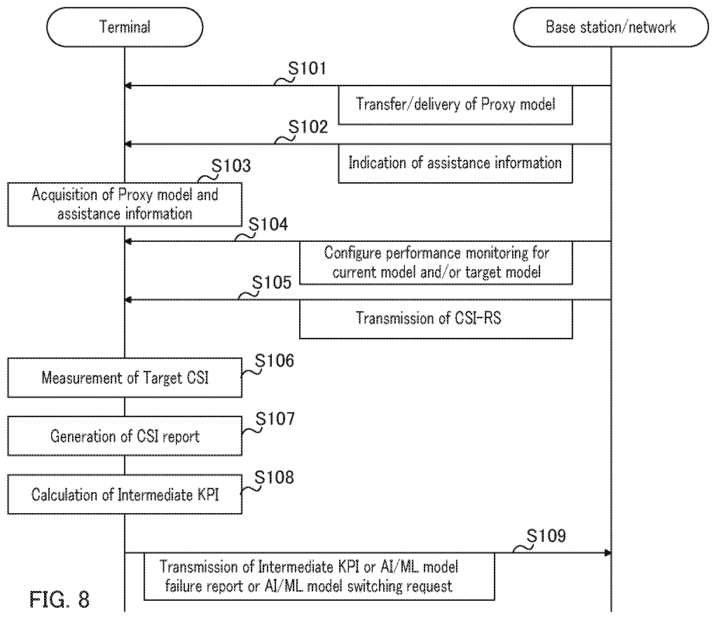

FIG. 8 illustrates an operation example of terminal 200 and a base station/network (e.g., base station 100) according to the present embodiment.

### <S101>

For example, the base station/network transmits (or transfers and delivers) information related to the proxy model to terminal 200.

The proxy model in the present embodiment is, for example, an AI/ML model that targets a plurality of AI/mL models for performance monitoring for the AT/ML model.

### <S102>

The base station/network indicates, to terminal 200, individual pieces of assistance information for the plurality of A/ML models targeted by the proxy model. The assistance information may include, for example, difference information of an Intermediate KPI corresponding to each of the plurality of AI/ML models with respect to the Intermediate KPI based on output of the proxy model. For example, the assistance information may be information indicating a relationship between a difference in Intermediate KPI (e.g., NMSE or SGCS) between an actual AI/ML model and the proxy model, which is given by identification information such as a model ID, a functional ID, and a pairing ID.

### <S103>

Terminal 200 acquires the information related to the proxy model and the assistance information (e.g., difference information). Note that, the information related to the proxy model may be defined previously by standard and held by terminal 200 or may be semi-statically configured for terminal 200, for example. Further, for example, the assistance information (e.g., difference information) may be defined previously by standard and may be held by terminal 200 or may be semi-statically configured for terminal 200.

### <S104>

The base station/network configures terminal 200 to perform the performance monitoring for the currently activated AI/ML model (current model) and the currently-not activated target AI/ML model (AI/ML model as a switching candidate, target model).

In this case, terminal 200 can execute the performance monitoring for the AI/ML model in the operation described below.

### <S105, S106>

The base station/network transmits a reference signal (e.g., CSI reference signal (CSI-RS)) to terminal 200. Terminal 200 measures the target CSI (ground-truth CSI) based on the reference signal (e.g., CSI-RS).

### <S107>

Terminal 200 generates, for example, a CSI report (compression CSI) by inputting the measured target CSI to the AI/ML model (CSI generation model) of the CSI generator and reports the CSI report to the base station/network.

### <S108>

Terminal 200 inputs the CST report (compression CSI) to the proxy model that emulates the CST reconstructor (CSI reconstruction model) on the base station/network side and generates virtual reconstructed CSI, for the performance monitoring. Then, terminal 200 calculates an Intermediate KPI for the AI/ML model to be a target for the performance monitoring, by using the target CSI, the virtual reconstructed CSI, and the difference information of the Intermediate KPI.

Terminal 200 may calculate an Intermediate KPI of a specific AI/ML model (e.g., NMSE or SGCS) I_{KPI} in accordance with Expression 1 below.

$$( Expression 1 )$$

$${I}_{KPI} = {I}_{proxy} + {I}_{gap , i} \qquad [ 1 ]$$

In Expression 1, I_{proxy} indicates an Intermediate KPI (e.g., a value of NMSE or SGCS) between the target CSI and the virtual reconstructed CSI (output of the proxy model) generated by using the proxy model, and I_{gap,i} indicates difference information of the Intermediate KPI corresponding to the specific AI/ML model (e.g., model ID #i).

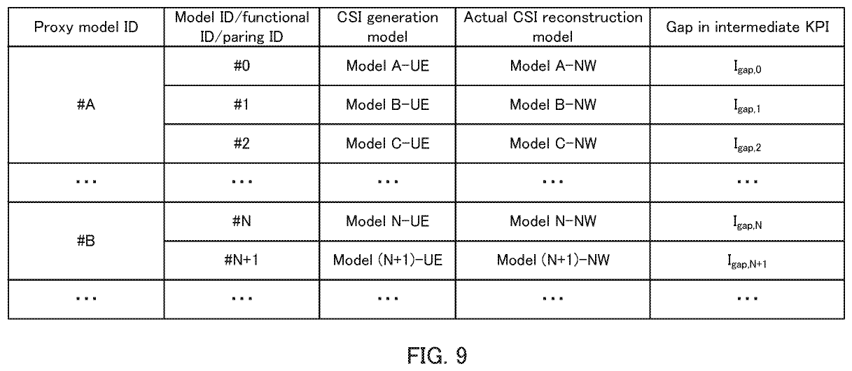

FIG. 9 illustrates an example of the assistance information in the present embodiment. For example, in FIG. 9, proxy model #A corresponds to AI/ML models (AI/ML models A, B, and C) of model IDs/functional IDs/pairing IDs #0 to #2, and a proxy model #B corresponds to AI/ML models (AI/ML models N and N+1) of model IDs/functional IDs/pairing IDs #N and #N+1. Further, as illustrated in FIG. 9, the assistance information includes difference information (Gap in intermediate KPI) with respect to the Intermediate KPI calculated by using the corresponding proxy model for each AI/ML model.

For example, terminal 200 calculates the Intermediate KPI of each of the AI/ML models (AI/ML models A, B, and C) of the model IDs #i (i=0 to 2) by using the Intermediate KPI calculated by using the proxy model #A (I_{proxy} in Expression 1) and difference information (I_{gap,0}, I_{gap,1}, and I_{gap,2}) of the Intermediate KPIs corresponding to the model ID #i (i=0 to 2) corresponding to the proxy model #A.

The method of calculating the Intermediate KPI is not limited to the above-described example. For example, the Intermediate KPI (I_{KPI}) may be calculated as in Expression 2.

$$( Expression 2 )$$

$${I}_{KPI} = {α}_{scaling , i} \cdot {I}_{proxy} \qquad [ 2 ]$$

In Expression 2, α_{scaling,i} indicates difference information (scaling coefficient) of the Intermediate KPI corresponding to the specific AI/ML model (e.g., model ID #i). For example, the assistance information may include α_{scaling,i} indicates corresponding to each AI/ML model as the difference information.

Further, for example, both I_{gap,i} and α_{scaling,i} indicates may be used as the method for calculating the Intermediate KPI.

### <S109>

Terminal 200 may execute, for example, at least one of the following operations for activation/deactivation/switching of an AI/ML model.

For example, the terminal may report, to the base station/network, at least one of the Intermediate KPIs of the currently activated AI/ML model and the target AI/ML model calculated by the above-described method. The base station/network may instruct terminal 200 to activate/deactivate/switch the AI/ML model, based on the Intermediate KPI reported from terminal 200.

Further, for example, in a case where the Intermediate KPI of the currently activated AI/ML model calculated by the above-described method is equal to or less than a threshold value (or less than the threshold value), terminal 200 may report a failure of the currently activated AI/ML model to the base station/network. The base station/network may instruct terminal 200 to deactivate/switch the currently activated AI/ML model, based on the failure report of the AI/ML model reported from terminal 200.

Further, for example, in a case where the Intermediate KPI of the target AI/ML model calculated by the above-described method is equal to or greater than the threshold value (or greater than the threshold value), terminal 200 may indicate, to the base station/network, a switching request to the target AI/ML model. The base station/network may instruct terminal 200 to deactivate the currently activated AI/ML model and switch to the target AI/ML model, based on the switching request for the AI/ML model reported from terminal 200.

The report of the Intermediate KPI, the failure report of the AI/ML model, and the switching request for the AI/ML model described above may be transmitted using a control plane message, such as uplink control information (UCI) or a Medium Access Control-Control Element (MAC-CE), or may be transmitted using a user plane message.

The operation examples of terminal 200 and the base station/network according to the present embodiment have been described thus far.

In the present embodiment, terminal 200 transmits a signal related to an AI/ML model (e.g., a report of Intermediate KPI, a failure report of AI/ML model, and a switching request of AI/ML model), based on the information related to the proxy model that emulates the CSI reconstruction model on the base station/network side. Further, for example, one proxy model targets a plurality of AI/ML models. For example, terminal 200 uses a value of an Intermediate KPI based on the output of one (or a specified number of) proxy model(s) and difference information for emulating each AI/ML model in the calculation of the Intermediate KPI. For example, in the example of FIG. 9, the inference processing of one proxy model of model ID #A is executed to calculate the Intermediate KPIs of three AI/ML models of model IDs #0 to #2. As described above, terminal 200 need not execute the inference processing of the plurality of proxy models in the performance monitoring for the plurality of AI/ML models. Therefore, the number of proxy models held by terminal 200 and the number of proxy models for executing the inference processing can be suppressed, and the calculation processing amount, the storage amount, and the power consumption of terminal 200 can be reduced, and the performance monitoring for the plurality of AI/MI models can be implemented. Further, for example, the overhead related to the transfer/delivery of the proxy model in a case where the Mobility occurs can be reduced.

Further, in the present embodiment, terminal 200 applies an individual piece of assistance information (e.g., difference information) to the AI/ML model for emulating each AI/ML model with respect to the value of the Intermediate KPI calculated by using one (or a specified number of) proxy model(s). That is, terminal 200 calculates the Intermediate KPI of each of the plurality of AI/ML models based on the output of the proxy model and the assistance information. As a result, terminal 200 can improve the calculation accuracy of the Intermediate KPI of each AI/ML model, and thus can improve the accuracy of the performance monitoring for the AI/ML model.

Therefore, according to the present embodiment, it is made possible to improve the efficiency of radio communication.

### (Variation 1)

In Embodiment 1, an example has been described in which the difference information of the Intermediate KPI (e.g., I_{gap,i} in Expression 1 or α_{scaling,i} indicates in Expression 2) used together with the Intermediate KPI (e.g., I_{proxy}) calculated by using the proxy model is given as a fixed value for each AI/ML model. However, the difference information of the Intermediate KPI is not limited to the fixed value and may be a variable value.

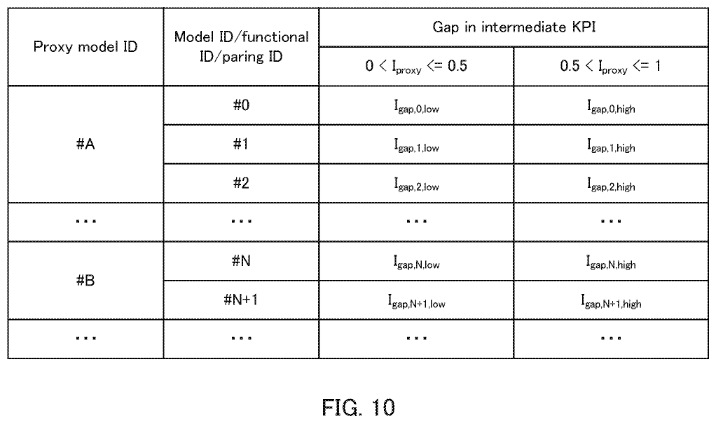

For example, a different value may be set as the difference information of the Intermediate KPI according to the value of the Intermediate KIP calculated by using the proxy model. For example, as illustrated in FIG. 10, a threshold value may be set for the Intermediate KPI (I_{proxy}) calculated by using the proxy model, and the difference information of the Intermediate KPI (e.g., I_{gap,i} in Expression 1 or α_{scaling,i} indicates in Expression 2) may be varied according to a magnitude relationship between I_{proxy} and the threshold value.

For example, in the example of FIG. 10, difference information I_{gap,i,low} is applied when I_{proxy} is equal to or less than the threshold value (0.5), and difference information I_{gap,i,high} is applied when I_{proxy} is greater than the threshold value (0.5). I_{gap,i,high} may be a value larger than I_{gap,i,low} or may be a value smaller than I_{gap,i,low}.

Further, the difference information (I_{gap,i}) of the Intermediate KPI may be given as a function of the Intermediate KPI (I_{proxy}) calculated by using the proxy model (e.g., I_{gap,i}=f(I_{proxy})).

According to Variation 1, even in a case where there is a difference in accuracy between the proxy model and the actual AI/ML model, the performance monitoring can be appropriately implemented by using the proxy model based on the value of the Intermediate KPI.

Note that, Variation 1 may be applied to Embodiment 2 described below by replacing the Intermediate KPI with a CQI. Further, although the example in which the difference information I_{gap,i,low} is used has been described, the same applies to a case where the difference information α_{scaling,i} indicates is used.

### (Variation 2)

The difference information of an Intermediate KPI is not limited to a case where a fixed value is given for each model, and for example, a different value may be used according to an applicable condition, such as a configuration, a scenario, and a moving speed of terminal 200.

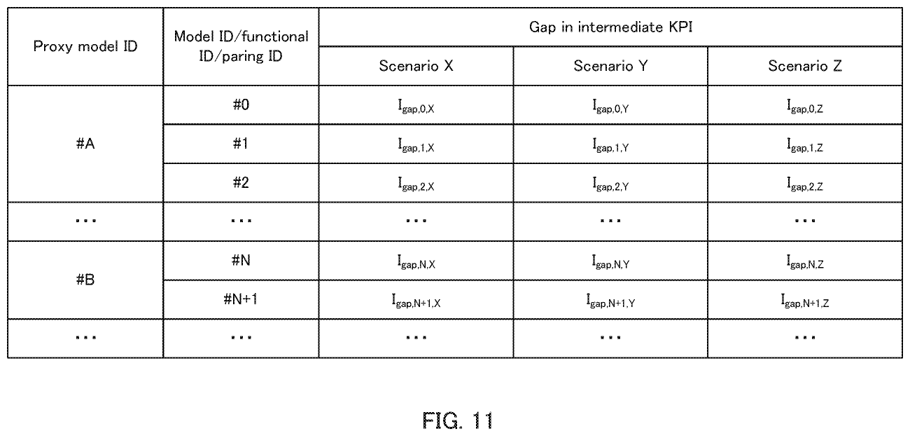

FIG. 11 illustrates an example in which the difference information I_{gap,0} of the Intermediate KPI is different according to a scenario (scenarios X, Y, and Z) as an example of the applicable condition.

It is assumed that the AI/ML model is trained under a specific applicable condition. Therefore, when the applicable condition is different, the performance of the actual AI/ML model may be different. Therefore, varying the difference information between the proxy model and the actual AI/ML model according to the applicable condition makes it possible to implement the performance monitoring with higher accuracy, using the proxy model.

Note that, Variation 2 may be applied to Embodiment 2 described below by replacing the Intermediate KPI with a CQI. Further, although the example has been described in which the difference information I_{gap,1} is used, the same applies to a case where the difference information α_{scaling,i} is used.

### (Variation 3)

In the performance monitoring for the AI/ML model, in a case where terminal 200 performs a failure report of an AI/ML model or a switching request for the AI/ML model based on a threshold value of an Intermediate KPI, instead of indicating, to terminal 200, the difference information of the Intermediate KPI described above, the threshold value of the Intermediate KPI for the failure report of the AI/ML model or the switching request for the AI/ML model may be indicated to terminal 200.

For example, the threshold value of the Intermediate KPI for the failure report of the AI/ML model or the switching request for the AI/ML model may be varied for each AI/ML model targeted by the proxy model.

For example, when the Intermediate KPI (I_{proxy}) calculated by using the proxy model is equal to or less than (or less than) the threshold value indicated to terminal 200, terminal 200 may perform the failure report of the AI/ML model or the switching request for the AI/ML model.

### Embodiment 2

Base station 100 and terminal 200 according to the present embodiment may have the same configurations as those in Embodiment 1.

In the present embodiment, it is assumed that terminal 200 generates a CQI based on output of a proxy model that emulates an AI/ML model (e.g., CSI reconstruction model) of a CSI reconstructor on a base station/network side (e.g., base station 100), and reports the generated CQI to the base station/network side.

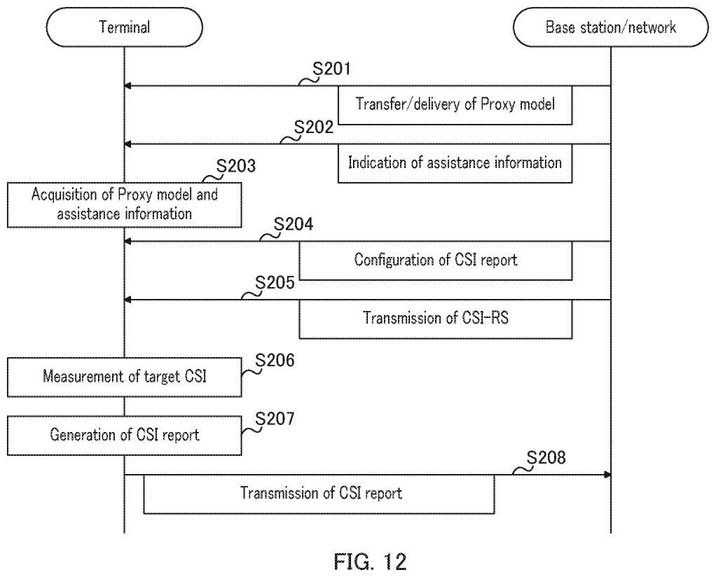

FIG. 12 illustrates an operation example of terminal 200 and the base station/network (e.g., base station 100) according to the present embodiment.

### <S201>

For example, the base station/network transmits (or transfers and delivers) information related to a proxy model to terminal 200.

The proxy model in the present embodiment is, for example, an AI/ML model that targets a plurality of AI/ML models for CQI reporting.

### <S202>

The base station/network indicates, to terminal 200, individual pieces of assistance information for the plurality of AI/ML models targeted by the proxy model. The assistance information may include, for example, difference information of a CQI corresponding to each of the plurality of AI/ML models with respect to the CQI based on the output of the proxy model. For example, the assistance information may be information indicating a relationship between a difference in CQI between an actual AI/ML model and the proxy model, which is given by identification information, such as a model ID, a functional ID, and a pairing ID.

### <S203>

Terminal 200 acquires the information related to the proxy model and the assistance information (e.g., difference information). Note that, the information related to the proxy model may be defined previously by standard and may be held by terminal 200 or may be semi-statically configured for terminal 200. Further, the assistance information (e.g., difference information) may be defined previously by standard and may be held by terminal 200 or may be semi-statically configured for terminal 200.

### <S204>

The base station/network configures terminal 200 to perform a CSI report (e.g., including a CQI report). For example, terminal 200 may be configured to report a compression CSI and a CQI using the AI/ML model that is currently activated.

In this case, terminal 200 can execute the CQI report in the operation described below.

### <S205, S206>

The base station/network transmits a reference signal (e.g., CSI-RS) to terminal 200. Terminal 200 measures a target CSI (ground-truth CSI) based on the reference signal (e.g., CSI-RS).

### <S207>

Terminal 200 generates, for example, a CSI report (compression CSI) by inputting the measured target CSI to the AI/ML model (CSI generation model) of the CSI generator.

Further, terminal 200 inputs the CSI report (compression CSI) to a proxy model that emulates the CSI reconstructor (CSI reconstruction model) on the base station/network side for the CQI report, for example, and generates a virtual reconstructed CSI. Then, terminal 200 calculates a CQI based on the virtual reconstructed CSI and calculates the CQI to be included in the CSI report, using a value of the CQI calculated from the virtual reconstructed CSI and the difference information of the CQI.

### <S208>

Terminal 200 transmits (or reports) the CSI report (e.g., including the compression CSI and the CQI) to the base station/network.

In the processing of S207, terminal 200 may calculate the CQI (e.g., CQI_{CQI}) of a specific AI/ML model as in Expression 3 below.

$$( Expression 3 )$$

$${CQI}_{CQI} = {CQI}_{proxy} - {CQI}_{gap , i} \qquad [ 3 ]$$

In Expression 3, CQI_{proxy} indicates a CQI calculated, using the target CSI and the virtual reconstructed CSI generated by using the proxy model, and CQI_{gap,i} indicates difference information of the CQI corresponding to the specific AI/ML model (e.g., model ID #i).

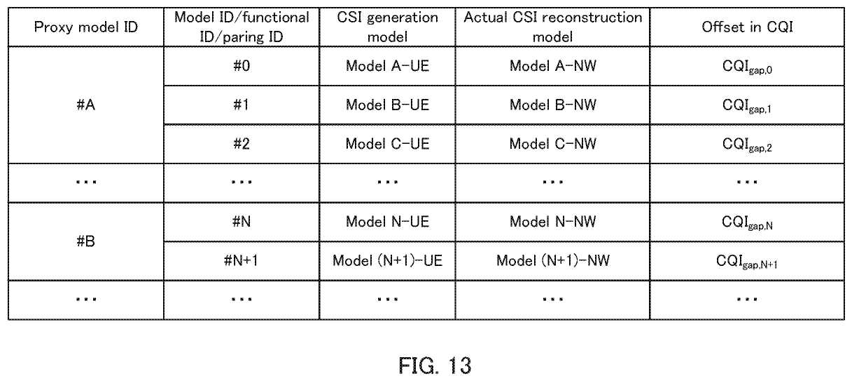

FIG. 13 illustrates an example of the assistance information in the present embodiment. For example, in FIG. 13, proxy model #A corresponds to AI/ML models (AI/ML models A, B. and C) of model IDs/functional IDs/pairing IDs #0 to #2, and proxy model #B corresponds to AI/ML models (AI/ML models N and N+1) of model IDs/functional IDs/pairing IDs #N and #N+1. Further, as illustrated in FIG. 13, the assistance information includes difference information (Offset in CQI) for a CQI (e.g., CQI_{proxy}) calculated, using the corresponding proxy model for each AI/ML model.

For example, terminal 200 calculates the CQI corresponding to each of the AI/ML models (AI/ML models A, B, and C) of the model IDs #i (i=0 to 2) by using the CQI (CQI_{proxy} in Expression 3) calculated, using the proxy model #A and difference information (CQI_{gap,0}, CQI_{gap,1}, and CQI_{gap,2}) of the CQIs corresponding to the model IDs #i (i=0 to 2) corresponding to the proxy model #A.

Note that, the method for calculating a CQI is not limited to the above-described example. For example, the CQI (CQI_{CQI}) may be calculated as in Expression 4.

$$( Expression 4 )$$

$${CQI}_{CQI} = ⌊ {CQI}_{proxy} / {α}_{scaling , i} ⌋ , or {CQI}_{CQI} = ⌈ {CQI}_{proxy} / {α}_{scaling , i} ⌉ \qquad [ 4 ]$$

In Expression 4, α_{scaling,i} indicates difference information (scaling coefficient) of the CQI corresponding to a specific AI/ML model (e.g., model ID #i). For example, the assistance information may include α_{scaling,i} corresponding to each AI/ML model as the difference information.

Further, for example, both CQI_{gap,i} and α_{scaling,i} may be used as the method for calculating a CQI.

The operation examples of terminal 200 and the base station/network according to the present embodiment have been described thus far.

In the present embodiment, terminal 200 transmits a signal (e.g., CQI) related to the CSI report based on the information related to the proxy model that emulates the CSI reconstruction model on the base station/network side. For example, terminal 200 uses a value of the CQI based on the output of the proxy model and difference information for emulating each AI/ML model in the calculation of the CQI. As a result, terminal 200 can calculate, in an emulated manner, the CQI for the CSI (reconstructed CSI) to be restored on the base station/network side and report the CQI to the base station/network. Therefore, terminal 200 need not execute the inference processing of the CSI reconstruction model on the base station/network side. As a result, the calculation processing amount, the storage amount, and the power consumption of terminal 200 can be reduced, and the problem related to compatibility that the CSI reconstructor on the base station/network side cannot be executed on the terminal side in terms of the processing amount can be reduced.

Further, in the present embodiment, one proxy model targets a plurality of AI/ML models. For example, terminal 200 uses a value of the CQI calculated based on the output of one (or a specified number of) proxy model(s) and difference information for emulating each AI/ML model in the calculation of the CQI. For example, in the example of FIG. 13, one proxy model of model ID #A is used to calculate the CQIs of three AI/ML models of model IDs #0 to #2. As a result, for example, the overhead related to the transfer/delivery of the proxy model when the Mobility occurs can be reduced.

Further, in the present embodiment, terminal 200 applies individual pieces of assistance information (e.g., difference information) to the AI/ML model for emulating each AI/ML model with respect to the value of the CQI calculated by using one (or a specified number of) proxy model(s). That is, terminal 200 calculates the CQI corresponding to each of the plurality of AI/ML models based on the output of the proxy model and the assistance information. As a result, terminal 200 can improve the calculation accuracy of the CQI of each AI/ML model.

Therefore, according to the present embodiment, it is made possible to improve the efficiency of radio communication.

### Embodiment 3

Base station 100 and terminal 200 according to the present embodiment may have the same configurations as those in Embodiment 1 or Embodiment 2.

In the present embodiment, as in Embodiment 2, terminal 200 generates a CQI based on output of a proxy model that emulates an AI/ML model (CSI reconstruction model) of a CSI reconstructor on a base station/network side (e.g., base station 100), and reports the generated CQI to the base station/network side. Further, terminal 200 performs the performance monitoring on the terminal side based on the output of the proxy model that emulates the AI/ML model (CSI reconstruction model) of the CSI reconstructor on the base station/network side, as in Embodiment 1.

The proxy model in the present embodiment is, for example, an AI/ML model that targets a plurality of applications for a CQI report and performance monitoring, and a plurality of AI/ML models. For example, the information related to the proxy model may be defined previously by standard and may be held by terminal 200 or may be semi-statically configured for terminal 200.

Further, individual pieces of assistance information for the plurality of AI/ML models targeted by the proxy model are indicated to terminal 200. The assistance information may include, for example, difference information of the CQI corresponding to each of the plurality of AI/ML models for the CQIs based on the output of the proxy model, and difference information of the Intermediate KPI corresponding to each of the plurality of AI/ML models for the Intermediate KPIs based on the output of the proxy model. For example, the assistance information may be information indicating a relationship between a difference in CQI and Intermediate KPI between an actual AI/ML model and the proxy model, which is given by identification information, such as a model ID, a functional ID, and a pairing ID. The assistance information (e.g., difference information) may be defined previously by standard and held by termina 200 or may be configured semi-statically for terminal 200.

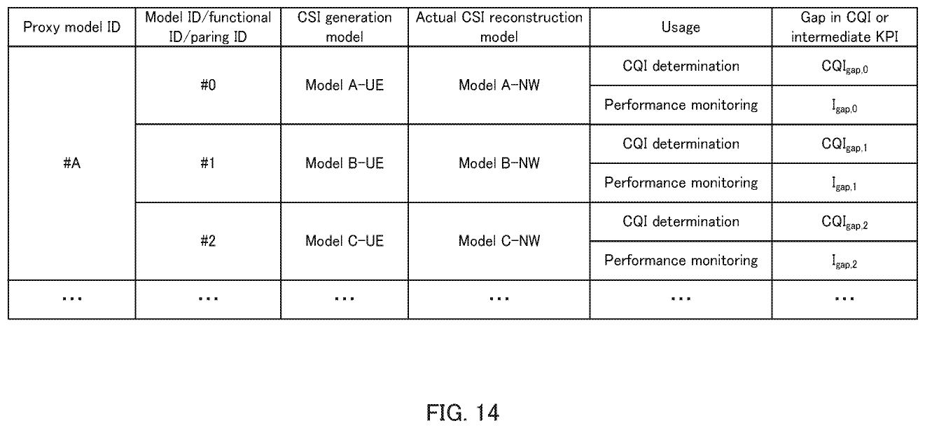

FIG. 14 illustrates an example of the assistance information in the present embodiment.

For example, in FIG. 14, proxy model #A corresponds to AI/ML models (AI/ML models A, B. and C) of model IDs/functional IDs/pairing IDs #0 to #2. Further, as illustrated in FIG. 14, the assistance information includes, for each of the AI/ML models corresponding to proxy model #A, difference information (CQI_{gap,i}) of each CQI corresponding to model ID #i (i=0 to 2) of Expression 3 used together with the CQI calculated by using the proxy model #A in calculating the CQI, and difference information (I_{gap,i}) of the Intermediate KPI calculated by using the proxy model #A in calculating the Intermediate KPI. Note that, the difference information of the Intermediate KPI may be I_{gap,i} of Expression 1 or α_{scaling,i} of Expression 2.

In the present embodiment, the operation related to the CQI report of terminal 200 may be the same as in Embodiment 2, and the operation related to the performance monitoring by terminal 200 may be the same as in Embodiment 1.

According to the present embodiment, terminal 200 can implement a plurality of pieces of processing having different applications (e.g., the CQI report and the performance monitoring) by performing the inference processing of one (or a specified number of) proxy model(s). Therefore, the number of proxy models which are held by terminal 200 and for which the inference processing is executed can be suppressed, and thus, it is made possible to reduce the calculation processing amount, the storage amount, and the power consumption of terminal 200. Further, for example, the overhead related to the transfer/delivery of the proxy model when the Mobility occurs can be reduced.

Each embodiment according to one non-limiting exemplary embodiment of the present disclosure has been described, thus far.

### [Regarding Architecture]

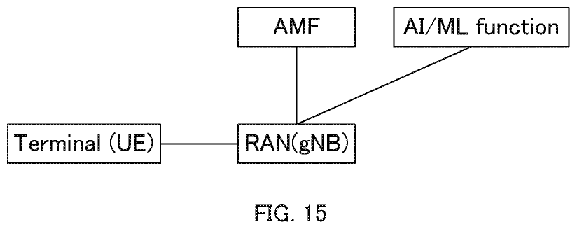

FIG. 15 illustrates an exemplary architecture including a function for processing AI/ML. Note that, a part of a network architecture may have the configuration illustrated in FIG. 15. Further, the function for processing AI/ML may be included in an Access and Mobility Management Function (AMF) or a RAN (gNB).

### [Configuration of Base Station]

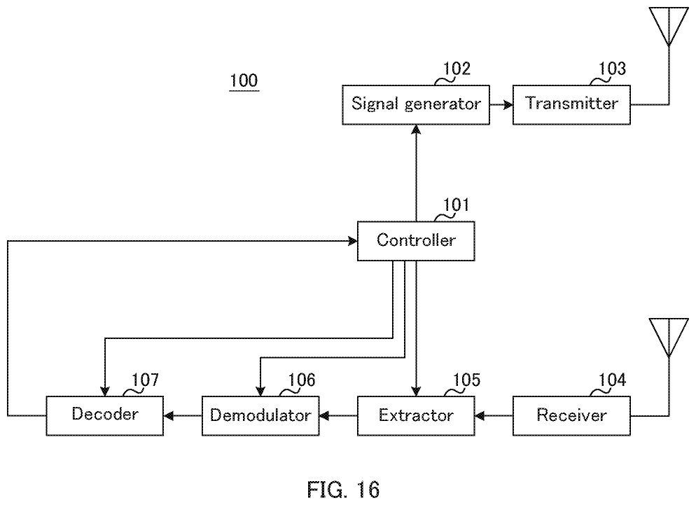

FIG. 16 is a block diagram illustrating a configuration example of base station 100. In FIG. 16, base station 100 includes controller 101, signal generator 102, transmitter 103, receiver 104, extractor 105, demodulator 106, and decoder 107.

Note that, transmitter 103 illustrated in FIG. 16 may be included in the transmitter illustrated in FIG. 6. Further, receiver 104 illustrated in FIG. 16 may be included in the receiver illustrated in FIG. 6.

Controller 101 determines control information related to a CSI report of terminal 200 and outputs the determined information to signal generator 102, for example. The control information related to the CSI report may include, for example, information related to performance monitoring for the AI/ML model, information related to the CQI report, information related to a proxy model, or assistance information (e.g., difference information). Further, when receiving the control information related to the AI/ML model of terminal 200 from the function for processing AI/ML (e.g., when receiving input from decoder 107), controller 101 may output the control information related to the AI/ML model to signal generator 102.

Further, controller 101 determines information for terminal 200 to receive a downlink signal and outputs the determined information to signal generator 102, for example. The information for terminal 200 to receive the downlink signal may include, for example, information related to resource allocation for a downlink data channel (e.g., Physical Downlink Shared Channel (PDSCH)) or a downlink control channel (e.g., Physical Downlink Control Channel (PDCCH)), and information related to a coding and modulation scheme (e.g., Modulation and Coding Scheme (MCS)).

Further, controller 101 determines information for terminal 200 to transmit an uplink signal and outputs the determined information to signal generator 102, extractor 105, demodulator 106, and decoder 107, for example. The information for terminal 200 to transmit the uplink signal may include, for example, information related to resource allocation for an uplink data channel (e.g., Physical Uplink Shared Channel (PUSCH)) or an uplink control channel (e.g., Physical Uplink Control Channel (PUCCH)), information related to a coding and modulation scheme (e.g., MCS), and information related to CSI reporting.

Signal generator 102 generates a data signal or a control signal bit sequence, using the information input from controller 101 and applies encoding as necessary, for example. Further, signal generator 102 modulates the encoded bit sequence to generate a modulated signal (e.g., symbol sequence) and maps the modulated signal to a radio resource indicated by the instruction from controller 101. Signal generator 102 outputs the signal for which mapping is performed to transmitter 103.

Transmitter 103 performs transmission waveform generation processing, such as OFDM on the signal input from signal generator 102, for example. Further, transmitter 103 performs, in case of OFDM transmission using a cyclic prefix (CP), Inverse Fast Fourier Transform (IFFT) processing on the signal and adds the CP to the signal after IFFT, for example. Further, for example, transmitter 103 performs RF processing, such as D/A conversion or up-conversion, on the signal and transmits a radio signal to terminal 200 via an antenna.

Receiver 104 performs RF processing, such as down-conversion or A/D conversion, on the uplink signal received from terminal 200 via an antenna, for example. Further, in case of OFDM transmission, receiver 104 performs Fast Fourier Transform (FFT) processing on the received signal and outputs the obtained frequency domain signal to extractor 105, for example.

Extractor 105 extracts a radio resource portion by which the uplink signal (e.g., PUSCH or PUCCH) is transmitted from the received signal input from receiver 104, based on the information input from controller 101 and outputs the extracted radio resource portion to demodulator 106, for example.

Demodulator 106 demodulates the uplink signal (e.g., PUSCH or PUCCH) input from extractor 105, based on the information input from controller 101, for example. Demodulator 106 outputs, for example, the demodulation result to decoder 107.

Decoder 107 performs error correction decoding of the uplink signal (e.g., PUSCH or PUCCH), based on the information input from controller 101 and the demodulation result input from demodulator 106, to obtain a decoded received bit sequence, for example. When the decoded received bit sequence includes control information related to the AI/ML model of terminal 200, decoder 107 outputs, for example, the information related to the AI/ML model to controller 101. Further, for example, when the received bit sequence after decoding includes information related to a CSI report from terminal 200 or performance monitoring for the AI/ML model (e.g., Intermediate KPI, failure report of AI/ML model, or switching request for AI/ML model), decoder 107 outputs the information to controller 101.

### [Configuration of Terminal]

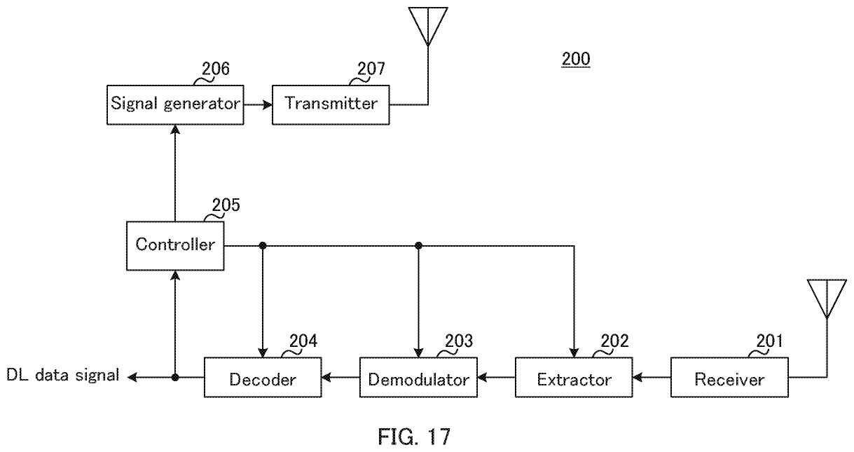

FIG. 17 is a block diagram illustrating a configuration example of terminal 200 according to one example of the present disclosure. For example, in FIG. 17, terminal 200 includes receiver 201, extractor 202, demodulator 203, decoder 204, controller 205, signal generator 206, and transmitter 207.

Note that, receiver 201 illustrated in FIG. 17 may be included in the receiver illustrated in FIG. 7. Further, transmitter 207 illustrated in FIG. 17 may be included in the transmitter illustrated in FIG. 7.

Receiver 201 receives a downlink signal (e.g., downlink data signal or downlink control signal) from base station 100 via an antenna and performs RF processing, such as down-conversion or A/D conversion, on a radio received signal to obtain a received signal (baseband signal), for example. Further, when receiving an OFDM signal, receiver 201 performs FFT processing on the received signal and converts the received signal into the frequency domain. Receiver 201 outputs the received signal to extractor 202.

Extractor 202 extracts a radio resource portion in which the downlink control signal can be included from the received signal input from receiver 201, based on information related to the radio resource of the downlink control signal input from controller 205 and outputs the extracted radio resource portion to demodulator 203, for example. Further, extractor 202 extracts a radio resource portion including a downlink data signal, based on information on a radio resource of the data signal input from controller 205 and outputs the radio resource portion to demodulator 203.

Demodulator 203 demodulates, based on information input from controller 205, the signal input (e.g., PDCCH or PDSCH) from extractor 202 and outputs the demodulation result to decoder 204, for example.

Decoder 204 performs error correction decoding of PDCCH or PDSCH using the information input from controller 205 and the demodulation result input from demodulator 203 and obtains the control signal or the downlink data signal, for example. Decoder 204 outputs the control signal to controller 205.

Controller 205 specifies information related to downlink transmission based on information obtained from the control signal input from decoder 204 and outputs the specified information to extractor 202, demodulator 203, and decoder 204, for example. Further, controller 205 specifies information related to the uplink transmission based on the information obtained from the control signal input from decoder 204 and outputs the specified information to signal generator 206, for example. Further, controller 205 generates a CSI report or control information related to performance monitoring for the AI/ML model by the above-described method and outputs the CSI report or the control information to signal generator 206.

Signal generator 206 generates an uplink data signal or an uplink control signal based on the CSI report, the control information related to performance monitoring for the AI/ML model or information related to the uplink transmission input from controller 205 and encodes and modulates a bit sequence of the generated signal to map the bit sequence to a radio resource. Signal generator 206 outputs, for example, the uplink signal to which the signal is mapped to transmitter 207.

Transmitter 207 generates a transmission signal waveform, such as OFDM, for the signal inputted from signal generator 206, for example. Further, transmitter 207 performs IFFT processing on the signal in case of OFDM transmission or DFT-s-OFDM transmission using a CP and adds the CP to the signal subjected to the IFFT, for example. Further, in a case where transmitter 207 generates a single carrier waveform, such as a DFT-s-OFDM waveform, for example, a DFT part may be added in front of signal generator 206 (not illustrated). Further, for example, transmitter 207 performs RF processing, such as D/A conversion and up-conversion, on the transmission signal and transmits a radio signal to base station 100 via an antenna.

### [Configuration of Controller of Terminal]

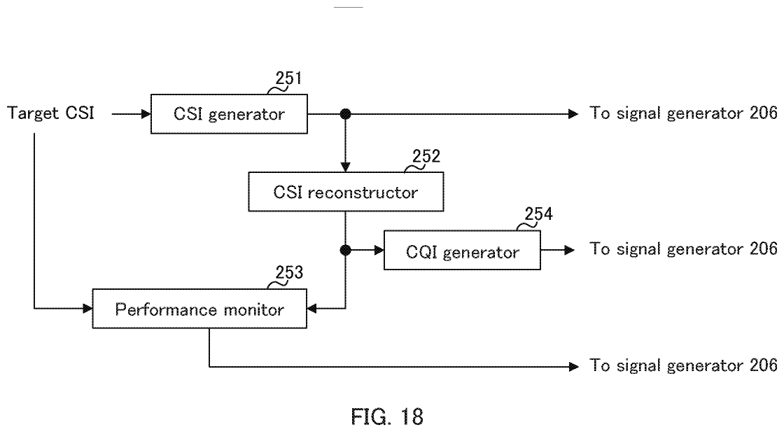

FIG. 18 is a block diagram illustrating a configuration example of a processor related to a CSI report and performance monitoring for an AI/ML model in controller 205 of terminal 200 according to one example of the present disclosure. For example, in FIG. 18, controller 205 includes CSI generator 251, CSI reconstructor 252, performance monitor 253, and CQI generator 254.

For example, a CSI (target CSI) calculated based on CSI-RS is input to CSI generator 251 and performance monitor 253.

CSI generator 251 compresses the target CSI using an encoder to generate a compression CSI. CSI generator 251 outputs the generated compression CSI to CSI reconstructor 252 and signal generator 206, for example.

CSI reconstructor 252 reconstructs the compression CSI using the proxy model and the compression CSI input from CSI generator 251, for example. CSI reconstructor 252 outputs the reconstructed CSI to performance monitor 253 and CQI generator 254.

Performance monitor 253 performs performance monitoring for an AI/ML model by using the input target CSI and the reconstructed CSI input from CSI reconstructor 252, for example. For example, performance monitor 253 may perform the performance monitoring for the AI/ML model by using the proxy model and the assistance information as in Embodiment 1 or Embodiment 3. Performance monitor 253 outputs information related to the performance monitoring for the AI/ML model (e.g., Intermediate KPI, failure report of the AI/ML model, or switching request for the AI/ML model) to signal generator 206.

CQI generator 254 generates a CQI using the reconstructed CSI input from CSI reconstructor 252 as in Embodiment 2 or Embodiment 3, for example. CQI generator 254 outputs the generated CQI to signal generator 206.

### OTHER EMBODIMENTS

The “AI/ML model” in the present disclosure may include a physical model, a binary model, an executable model, a converted model, a source code model, a non-executable model, a raw model, and a logical model, or may be another model form different from the aforementioned models.

Further, the applications targeted by a proxy model in the above-described embodiments are not limited to a CQI report and performance monitoring for the AU/ML model and may be another application. Further, the information on CSI feedback to which the AI/ML model is applied in the above-described embodiments is not limited to the information on the CSI in the frequency domain and the spatial domain, and may be, for example, information on the CSI in at least one of the frequency domain, the spatial domain, and the time domain.

Further, the use case to which the above-described embodiments are applied is not limited to CSI compression and can be applied to any use case in which an AI/ML model is placed on a terminal side. For example, examples of the use case in which an AI/ML model is placed on the terminal side include CSI prediction by the AI/ML model on the terminal side, beam prediction in the spatial domain or the time domain by the AI/ML model on the terminal side, and positioning accuracy enhancement by the AI/ML model on the terminal side.

Further, the AI/ML model is not limited to a case corresponding to a cell, a site, a transmission and reception point (TRP), a beam, or a location, and for example, there is also a possibility that different AI/ML models are used depending on other specific parameters, such as a moving speed of a terminal, a radio channel, such as multipath, a congestion situation of a cell, and a traffic to be transmitted. For example, a relationship between these specific parameters and the assistance information of the AI/ML models may be indicated to terminal 200.

Further, the term “Mobility” used in the above-described embodiments may include handover in an RRC CONNECTED mode and reselection in an RRC IDLE or RRC INACTIVE mode. Further, the term “Mobility” may include movement between TRPs, beam switching, position (location) movement, and the like.

Further, in the present disclosure, the signal/message/signaling used for indication may be a control plane message (e.g., UCI or MAC-CE), may be an RRC signal, or may be an indication via a DCI, which is physical layer signaling.

### (Complement)

Information indicating whether terminal 200 supports the functions, operations, or pieces of processing that have been indicated in the above-mentioned embodiments and complements may be transmitted (or indicated) from terminal 200 to base station 100, as capability information or a capability parameter for terminal 200, for example.

The capability information may include information elements (IEs) that individually indicate whether terminal 200 supports at least one of the functions, operations, or pieces of processing that have been described in the above-mentioned embodiments, variations, and complements. Alternatively, the capability information may include information elements that indicate whether terminal 200 supports a combination of any two or more of the functions, operations, or pieces of processing that have been described in the above-mentioned embodiments, variations, and complements.

Base station 100 may determine (or decide or assume), for example, based on the capability information received from terminal 200, the functions, operations, or processes that are supported (or not supported) by terminal 200, which is a transmission source of the capability information. Base station 100 may execute operations, processes, or control in accordance with a determination result based on the capability information. For example, base station 100 may control the processing related to the AI/ML model based on the capability information received from terminal 200.

Note that, in a case where terminal 200 does not entirely support the functions, operations, or pieces of processing described in the above-mentioned embodiments, variations, and complements, such an unsupported part of the functions, operations, or processes may be interpreted as a limitation in terminal 200. For example, information or a request relating to such limitation may be indicated to base station 100.

The information on the capability or the limitation of terminal 200 may be defined by standards or may be implicitly indicated to base station 100 in association with information known in base station 100 or information to be transmitted to base station 100, for example.

Each embodiment, each variation, and the complements according to one non-limiting exemplary embodiment of the present disclosure have been each described, thus far.

### (Control Signals)

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sidelink control information (SCI) or the 2nd stage SCI.

### (Base Station)

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, the base station may be replaced with a terminal. The base station may be a relay apparatus that relays communication between a higher node and a terminal. The base station may be a roadside unit as well.

### (Uplink/Downlink/Sidelink)

The present disclosure may be applied to any of uplink, downlink and sidelink. The present disclosure may be applied to, for example, uplink channels, such as PUSCH. PUCCH, and PRACH, downlink channels, such as PDSCH. PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### (Data Channels/Control Channels)

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### (Reference Signals)

In the present disclosure, the reference signals are signals known to both a base station and a mobile station and each reference signal may be referred to as a Reference Signal (RS) or sometimes a pilot signal. The reference signal may be any of a DMRS, a Channel State Information—Reference Signal (CSI-RS), a Tracking Reference Signal (TRS), a Phase Tracking Reference Signal (PTRS), a Cell-specific Reference Signal (CRS), and a Sounding Reference Signal (SRS).

### (Time Intervals)

In the present disclosure, time resource units are not limited to one or a combination of slots and symbols, and may be time resource units, such as frames, superframes, subframes, slots, time slots, subslots, minislots, or time resource units, such as symbols, Orthogonal Frequency Division Multiplexing Access (OFDM) symbols, Single Carrier-Frequency Division Multiple Access (SC-FDMA) symbols, or other time resource units. The number of symbols included in one slot is not limited to any number of symbols exemplified in the embodiment(s) described above, and may be other numbers of symbols.

### (Frequency Bands)

The present disclosure may be applied to any of a licensed band and an unlicensed band.

### (Communication)

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

Further, the present disclosure may be applied to any of a terrestrial network or a network other than a terrestrial network (NTN: Non-Terrestrial Network) using a satellite or a High Altitude Pseudo Satellite (HAPS). Further, the present disclosure may be applied to a network having a large cell size, and a terrestrial network with a large delay compared with a symbol length or a slot length, such as an ultra-wideband transmission network.

### (Antenna Ports)

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

### <5G NR System Architecture and Protocol Stack>

3GPP has been working on the next release for the 5th generation cellular technology (simply called “5G”), including the development of a new radio access technology (NR) operating in frequencies ranging up to 100 GHz. The first version of the 5G standard was completed at the end of 2017, which allows proceeding to 5G NR standard-compliant trials and commercial deployments of terminals (e.g., smartphones).

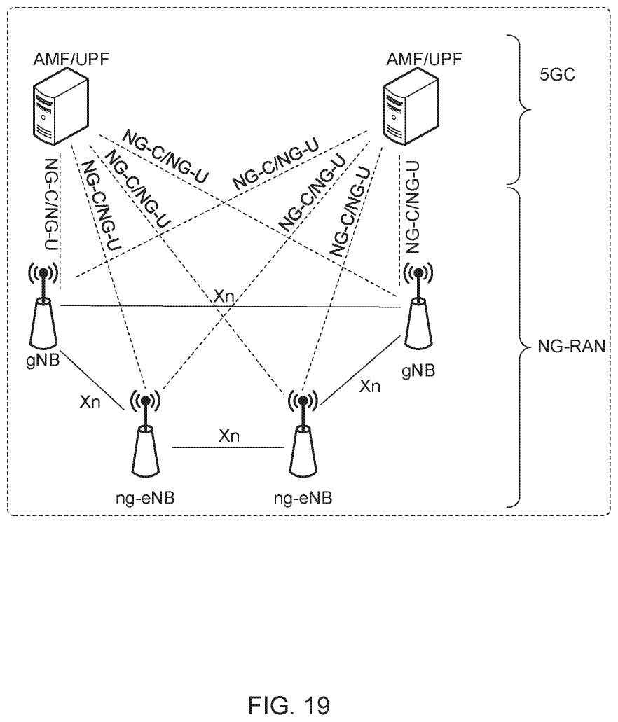

For example, the overall system architecture assumes an NG-RAN (Next Generation-Radio Access Network) that includes gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function)(e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 19 (see e.g., 3GPP TS 38.300 v15.6.0, section 4).

The user plane protocol stack for NR (see e.g., 3GPP TS 38.300, section 4.4.1) includes the PDCP (Packet Data Convergence Protocol, see clause 6.4 of TS 38.300), RLC (Radio Link Control, see clause 6.3 of TS 38.300) and MAC (Medium Access Control, see clause 6.2 of TS 38.300) sublayers, which are terminated in the gNB on the network side. Additionally, a new Access Stratum (AS) sublayer (SDAP, Service Data Adaptation Protocol) is introduced above the PDCP (see e.g., clause 6.5 of 3GPP TS 38.300). A control plane protocol stack is also defined for NR (see for instance TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For instance, the Medium Access Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. Examples of the physical channel include a Physical Random Access Channel (PRACH), a Physical Uplink Shared Channel (PUSCH), and a Physical Uplink Control Channel (PUCCH) as uplink physical channels, and a Physical Downlink Shared Channel (PDSCH), a Physical Downlink Control Channel (PDCCH), and a Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates on the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g., subcarrier spacing. OFDM symbol duration, cyclic prefix (CP) duration, and number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacings of 15 kHz, 30 kHz, and 60 kHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and each carrier, resource grids of subcarriers and OFDM symbols are defined respectively for uplink and downlink. Each element in the resource grids is called a resource element and is identified based on the frequency index in the frequency domain and the symbol position in the time domain (see 3GPP TS 38.211 v15.6.0).

### <Functional Split Between NG-RAN and 5GC in 5G NR>

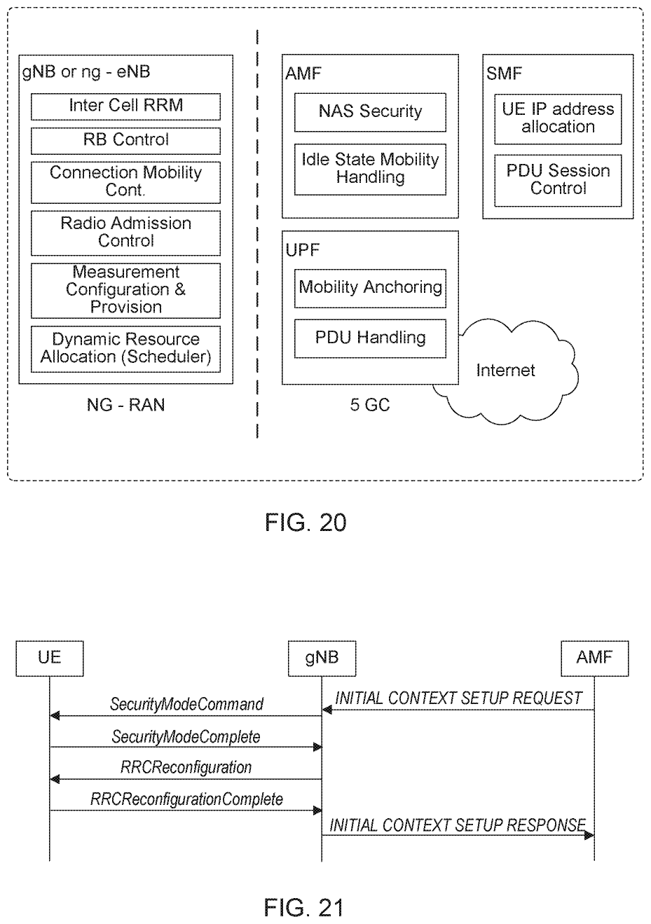

FIG. 20 illustrates the functional split between the NG-RAN and the 5GC. A logical node of the NG-RAN is gNB or ng-eNB. The 5GC includes logical nodes AMF, UPF, and SMF.

For example, gNB and ng-eNB hosts the following main functions:
Radio Resource Management functions such as Radio Bearer Control, Radio Admission Control, Connection Mobility Control, and dynamic allocation (scheduling) of both uplink and downlink resources to a UE;
IP header compression, encryption, and integrity protection of data;
Selection of an AMF during UE attachment in such a case when no routing to an AMF can be determined from the information provided by the UE;
Routing user plane data towards the UPF;
Routing control plane information towards the AMF;
Connection setup and release;
Scheduling and transmission of paging messages;
Scheduling and transmission of system broadcast information (originated from the AMF or an operation management maintenance function (OAM: Operation, Admission, Maintenance));
Measurement and measurement reporting configuration for mobility and scheduling;
Transport level packet marking in the uplink;
Session management;
Support of network slicing;
QoS flow management and mapping to data radio bearers;
Support of UEs in the RRC_INACTIVE state;
Distribution function for NAS messages;
Radio access network sharing;
Dual connectivity; and
Tight interworking between NR and E-UTRA.

The Access and Mobility Management Function (AMF) hosts the following main functions:
Function of Non-Access Stratum (NAS) signaling termination;
NAS signaling security;
Access Stratum (AS) security control;
Inter-Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing; and
Session Management Function (SMF) selection.

Further, the User Plane Function (UPF) hosts the following main functions:
Anchor Point for intra-/inter-RAT mobility (when applicable);
External Protocol Data Unit (PDU) session point for interconnection to a data network;
Packet routing and forwarding;
Packet inspection and a user plane part of Policy rule enforcement;
Traffic usage reporting;
Uplink classifier to support routing traffic flows to a data network;
Branching point to support multi-homed PDU session;
QoS handling for user plane (e.g., packet filtering, gating, UU/DL rate enforcement);
Uplink traffic verification (SDF to QoS flow mapping); and
Function of downlink packet buffering and downlink data notification triggering.

Finally, the Session Management Function (SMF) hosts the following main functions:
Session management;
UE IP address allocation and management;
Selection and control of UPF;
Configuration function for traffic steering at the User Plane Function (UPF) to route traffic to a proper destination;
Control part of policy enforcement and QoS; and
Downlink data notification.

### <RRC Connection Setup and Reconfiguration Procedure>

FIG. 21 illustrates some interactions between a UE, gNB, and AMF (a 5GC Entity) performed in the context of a transition of the UE from RRC_IDLE to RRC_CONNECTED for the NAS part (see TS 38 300 v15.6.0).

The RRC is higher layer signaling (protocol) used to configure the UE and gNB. With this transition, the AMF prepares UE context data (which includes, for example, a PDU session context, security key, UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a SecurityModeCommand message and by the UE responding to the gNB with the SecurityModeComplete message. Afterwards, the gNB performs the reconfiguration to setup the Signaling Radio Bearer 2 (SRB2) and Data Radio Bearer(s) (DRB(s)) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB indicates the AMF that the setup procedure is completed with INITIAL CONTEXT SETUP RESPONSE.

Thus, the present disclosure provides a 5th Generation Core (5GC) entity (e.g., AMF, SMF, or the like) including control circuitry, which, in operation, establishes a Next Generation (NG) connection with a gNodeB, and a transmitter, which in operation, transmits an initial context setup message to the gNodeB via the NG connection such that a signaling radio bearer between the gNodeB and a User Equipment (UE) is set up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### <Usage Scenarios of IMT for 2020 and Beyond>

FIG. 22 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 22 illustrates some examples of envisioned usage scenarios for IMT for 2020 and beyond (see e.g., ITU-R M.2083 FIG. 2).

The URLLC use case has stringent requirements for capabilities such as throughput, latency and availability. The URLLC use case has been envisioned as one of the enablers for future vertical applications such as radio control of industrial manufacturing or production processes, remote medical surgery, distribution automation in a smart grid, transportation safety. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, or the like. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, for example, for URLLC and mMTC, is high reliability or ultra-reliability. Several mechanisms can improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability improvement in general, regardless of particular communication scenarios.

For NR URLLC, further use cases with tighter requirements have been envisioned such as factory automation, transport industry and electrical power distribution. The tighter requirements are higher reliability (up to 10⁻⁶ level), higher availability, packet sizes of up to 256 bytes, time synchronization up to the extent of a few μs (where the value can be one or a few μs depending on frequency range and short latency on the order of 0.5 to 1 ms (in particular a target user plane latency of 0.5 ms), depending on the use cases).

Moreover, for NR URLLC, several technology enhancements from physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements are possible. The term “mini-slot” refers to a Transmission Time Interval (TTI) including a smaller number of symbols than a slot (a slot comprising fourteen symbols).

### <QoS Control>

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU sessions. For each UE, the NG-RAN establishes at least one Data Radio Bearer (DRB) together with the PDU session, e.g., as illustrated above with reference to FIG. 21. Further, additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

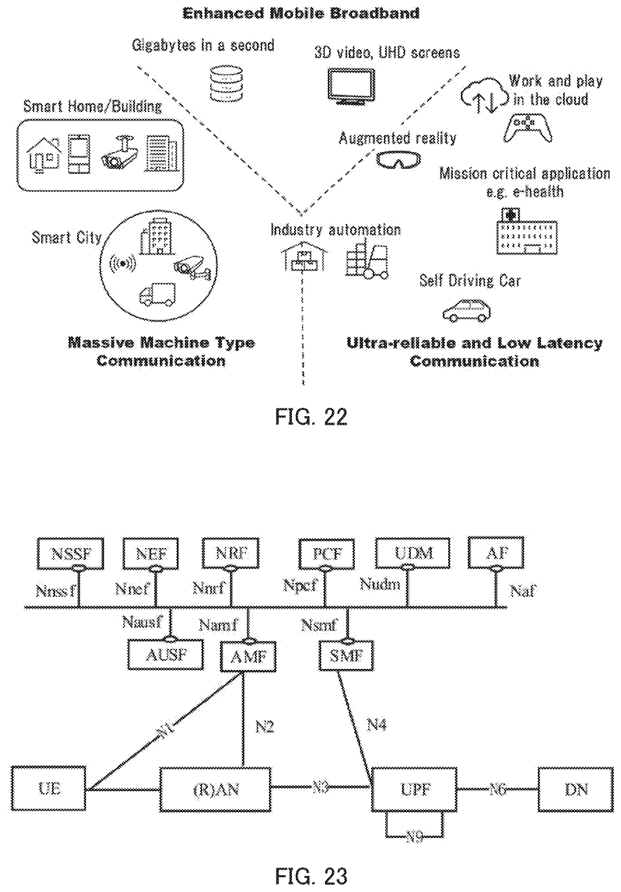

FIG. 23 illustrates a 5G NR non-roaming reference architecture (see TS 23.501 v16.1.0, section 4.23). An Application Function (AF) (e.g., an external application server hosting 5G services, exemplarily described in FIG. 22) interacts with the 3GPP Core Network in order to provide services. For example, in order to support application influencing on traffic routing, the interaction includes accessing Network Exposure Function (NEF) or interacting with the policy framework for policy control (e.g., QoS control) (see Policy Control Function, PCF). Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 23 illustrates further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN, e.g., operator services. Internet access, or third party services). All of or a part of the core network functions and the application services may be deployed and running on cloud computing environments.

In the present disclosure, thus, an application server (e.g., AF of the 5G architecture), is provided that includes: a transmitter, which in operation, transmits a request containing a QoS requirement for at least one of URLLC, eMMB and mMTC services to at least one of functions (such as NEF, AMF, SMF, PCF, and UPF) of the 5GC to establish a PDU session including a radio bearer between a gNodeB and a UE in accordance with the QoS requirement; and control circuitry, which, in operation, performs the services using the established PDU session.

In the description of the present disclosure, the term ending with a suffix, such as “-er” “-or” or “-ar” may be interchangeably replaced with another term, such as “circuit (circuitry),” “device,” “unit,” or “module.”

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. Further, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smartphone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a radio LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

A terminal according to one embodiment of the present disclosure includes: reception circuitry, which, in operation, receives first information related to a first model that emulates a reconstruction model on a network side with respect to channel state information generated based on a generation model on a terminal side, the first model targeting a plurality of artificial intelligence models or a plurality of applications; and transmission circuitry, which, in operation, transmits a signal related to at least one of an artificial intelligence model and/or the channel state information, based on the first information.

In one embodiment of the present disclosure, the reception circuitry receives individual pieces of second information for the plurality of artificial intelligence models, and the signal is individually generated for the plurality of artificial intelligence models or the plurality of applications, using the first information and the individual pieces of second information.

In one embodiment of the present disclosure, the signal includes an indicator in performance monitoring for each of the plurality of artificial intelligence models, based on output of the first model.

In one embodiment of the present disclosure, the first model is an artificial intelligence model that targets the plurality of artificial intelligence models for the performance monitoring, and the first information is defined by standard or is configured semi-statically for the terminal.

In one embodiment of the present disclosure, the signal includes an indicator in performance monitoring for each of the plurality of artificial intelligence models based on output of the first model and at least one of the individual pieces of second information, and the second information is information related to a difference of the indicator corresponding to each of the plurality of artificial intelligence models with respect to the indicator based on the output of the first model.

In one embodiment of the present disclosure, the second information is defined by standard or is configured semi-statically for the terminal.

In one example of the present disclosure, the signal includes a channel quality indicator (CQI) based on output of the first model, and the transmission circuitry transmits the CQI to the network side.

In one embodiment of the present disclosure, the first model is an artificial intelligence model that targets the plurality of artificial intelligence models for a report of the CQI, and the first information is defined by standard or is configured semi-statically for the terminal.

In one embodiment of the present disclosure, the signal includes a channel quality indicator (CQI) based on output of the first model and the individual pieces of second information, and the individual pieces of second information are each information related to a difference of the CQI corresponding to each of the plurality of artificial intelligence models with respect to the CQI based on the output of the first model.

In one embodiment of the present disclosure, the individual pieces of second information are defined by standard or are configured semi-statically for the terminal.

In one example of the present disclosure, the plurality of applications includes: performance monitoring for the artificial intelligence model based on output of the first model; and a report of a channel quality indicator (CQI) based on the output of the first model.

In one embodiment of the present disclosure, the first model is an artificial intelligence model that targets the plurality of artificial intelligence models for the performance monitoring and the report of the CQI, and the first information is defined by standard or is configured semi-statically for the terminal.

In one embodiment of the present disclosure, the plurality of applications includes: performance monitoring for the artificial intelligence model based on output of the first model; and a report of a channel quality indicator (CQI) based on the output of the first model, and the individual pieces of second information are each information related to a difference of an indicator corresponding to each of the plurality of artificial intelligence models with respect to the indicator in the performance monitoring based on the output of the first model, and information related to a difference of the CQI corresponding to each of the plurality of artificial intelligence models with respect to the CQI based on the output of the first model.

In one embodiment of the present disclosure, the individual pieces of second information are defined by standard or are configured semi-statically for the terminal.

A base station according to one embodiment of the present disclosure includes: transmission circuitry, which, in operation, transmits first information related to a first model that emulates a reconstruction model on a network side with respect to channel state information generated based on a generation model on a terminal side, the first model targeting a plurality of artificial intelligence models or a plurality of applications; and reception circuitry, which, in operation, receives a signal related to at least one of an artificial intelligence model and/or the channel state information, generated based on the first information.

In a communication method according to one embodiment of the present disclosure, a terminal receives first information related to a first model that emulates a reconstruction model on a network side with respect to channel state information generated based on a generation model on a terminal side, the first model targeting a plurality of artificial intelligence models or a plurality of applications, and the terminal transmits, based on the first information, a signal related to at least one of an artificial intelligence model and/or the channel state information.

In a communication method according to one embodiment of the present disclosure, a base station transmits first information related to a first model that emulates a reconstruction model on a network side with respect to channel state information generated based on a generation model on a terminal side, the first model targeting a plurality of artificial intelligence models or a plurality of applications, and the base station receives a signal related to at least one of an artificial intelligence model and/or the channel state information, generated based on the first information.

The disclosure of Japanese Patent Application No. 2023-071359, filed on Apr. 25, 2023, including the specification, drawings and abstract, is incorporated herein by reference in its entirety.

### INDUSTRIAL APPLICABILITY

One exemplary embodiment of the present disclosure is useful for radio communication systems.

### REFERENCE SIGNS LIST

100 Base station
101, 205 Controller
102, 206 Signal generator
103, 207 Transmitter
104, 201 Receiver
105, 202 Extractor
106, 203 Demodulator
107, 204 Decoder
200 Terminal
251 CSI generator
252 CSI reconstructor
253 Performance monitor
254 CQI generator

1. A terminal, comprising:
reception circuitry, which, in operation, receives first information related to a first model that emulates a reconstruction model on a network side with respect to channel state information generated based on a generation model on a terminal side, the first model targeting a plurality of artificial intelligence models or a plurality of applications; and
transmission circuitry, which, in operation, transmits a signal related to at least one of an artificial intelligence model and/or the channel state information, based on the first information.

2. The terminal according to claim 1, wherein,
the reception circuitry receives individual pieces of second information for the plurality of artificial intelligence models, and
the signal is individually generated for the plurality of artificial intelligence models or the plurality of applications, using the first information and the individual pieces of second information.

3. The terminal according to claim 1, wherein, the signal includes an indicator in performance monitoring for each of the plurality of artificial intelligence models, based on output of the first model.

4. The terminal according to claim 3, wherein, the first model is an artificial intelligence model that targets the plurality of artificial intelligence models for the performance monitoring, and the first information is defined by standard or is configured semi-statically for the terminal.

5. The terminal according to claim 2, wherein,
the signal includes an indicator in performance monitoring for each of the plurality of artificial intelligence models based on output of the first model and at least one of the individual pieces of second information, and
the second information is information related to a difference of the indicator corresponding to each of the plurality of artificial intelligence models with respect to the indicator based on the output of the first model.

6. The terminal according to claim 5, wherein, the second information is defined by standard or is configured semi-statically for the terminal.

7. The terminal according to claim 1, wherein,
the signal includes a channel quality indicator (CQI) based on output of the first model, and
the transmission circuitry transmits the CQI to the network side.

8. The terminal according to claim 7, wherein, the first model is an artificial intelligence model that targets the plurality of artificial intelligence models for a report of the CQI, and the first information is defined by standard or is configured semi-statically for the terminal.

9. The terminal according to claim 2, wherein,
the signal includes a channel quality indicator (CQI) based on output of the first model and the individual pieces of second information, and
the individual pieces of second information are each information related to a difference of the CQI corresponding to each of the plurality of artificial intelligence models with respect to the CQI based on the output of the first model.

10. The terminal according to claim 9, wherein, the individual pieces of second information are defined by standard or are configured semi-statically for the terminal.

11. The terminal according to claim 1, wherein, the plurality of applications includes: performance monitoring for the artificial intelligence model based on output of the first model; and a report of a channel quality indicator (CQI) based on the output of the first model.

12. The terminal according to claim 11, wherein, the first model is an artificial intelligence model that targets the plurality of artificial intelligence models for the performance monitoring and the report of the CQI, and the first information is defined by standard or is configured semi-statically for the terminal.

13. The terminal according to claim 2, wherein,
the plurality of applications includes: performance monitoring for the artificial intelligence model based on output of the first model; and a report of a channel quality indicator (CQI) based on the output of the first model, and
the individual pieces of second information are each information related to a difference of an indicator corresponding to each of the plurality of artificial intelligence models with respect to the indicator in the performance monitoring based on the output of the first model, and information related to a difference of the CQI corresponding to each of the plurality of artificial intelligence models with respect to the CQI based on the output of the first model.

14. The terminal according to claim 13, wherein, the individual pieces of second information are defined by standard or are configured semi-statically for the terminal.

15. A base station, comprising:
transmission circuitry, which, in operation, transmits first information related to a first model that emulates a reconstruction model on a network side with respect to channel state information generated based on a generation model on a terminal side, the first model targeting a plurality of artificial intelligence models or a plurality of applications; and
reception circuitry, which, in operation, receives a signal related to at least one of an artificial intelligence model and/or the channel state information, generated based on the first information.

16. A communication method, comprising:
receiving, by a terminal, first information related to a first model that emulates a reconstruction model on a network side with respect to channel state information generated based on a generation model on a terminal side, the first model targeting a plurality of artificial intelligence models or a plurality of applications, and
transmitting, by the terminal, based on the first information, a signal related to at least one of an artificial intelligence model and/or the channel state information.

17. A communication method, comprising:
transmitting, by a base station, first information related to a first model that emulates a reconstruction model on a network side with respect to channel state information generated based on a generation model on a terminal side, the first model targeting a plurality of artificial intelligence models or a plurality of applications, and
receiving, by the base station, a signal related to at least one of an artificial intelligence model and/or the channel state information, generated based on the first information.
